(19) United States
(12) Patent Application Publication
(10) Pub. No.: US 2025/0284426 A1
(43) Pub. Date: Sep. 11, 2025

(54) STORAGE SYSTEMS AND METHODS

(71) Applicant: HITACHI, Ltd., Tokyo (JP)

(72) Inventors: Ryosuke TATSUMI, Sunnyvale, CA (US); Kazuei HIRONAKA, Campbell, CA (US)

(21) Appl. No.: 18/597,830

(22) Filed: Mar. 6, 2024

(51) Int. Cl. G06F 3/06

(52) U.S. Cl. CPC G06F 3/0647; G06F 3/0604; G06F 3/067

(57) ABSTRACT

Systems and methods described herein comprise a management system that, in response to obtaining from a volume of a source storage system, a fingerprint information, provide that information to candidate storage systems, which return estimates indicative of an amount of data storage each of the candidate storage systems would require to store the data. The management system then selects, among the candidate storage systems, one or more destination storage systems to transfer the data from the volume to the selected destination storage systems.

### BACKGROUND

### Field

The present disclosure is generally directed to data storage systems and methods, and more specifically, to data management systems and methods for optimizing data storage and transfer processes in cloud-like environments having several candidate destination storage devices.

### Related Art

As cloud and hybrid cloud storage technologies expand, multiple identical storage devices are operated side-by-side to ensure scalability. Data is transferred and copied between storage devices for data rebalancing, migration, disaster recovery, and similar tasks. In such applications, the amount of stored data is ideally reduced as much as possible, as operating costs are directly linked to the overall amount of data stored. Further, policy-based operational management methods are gaining ground due to a scarcity of IT administrators and the need for managing IT operations in scenarios where direct interaction with physical storage devices is limited or impractical.

Conventional methods for reducing the amount of data transferred largely rely on deduplication methods. For example, one method for preventing the transfer of duplicate data involves providing a backup server with duplication information during backup retrieval to determine whether the data to be transferred is duplicate and, if so, to cause the server to refrain from sending duplicate data to a backup destination. Another method for reducing the amount of data transfer involves checking whether backup data already exists at the destination device and, if so, not forwarding that data to avoid unnecessary re-transfers to the backup destination.

However, in addition to being computationally intensive, existing systems suffer from major drawbacks including that they only identify duplicates during the data transfer process to similar types of storage devices. This is mainly because deduplication information is typically generated at the moment the data is actually transferred. In situations where several candidate destination storage devices exist, it is nearly impossible to minimize duplication due to the inability to compare incoming data with what is already stored across the different types of destination storage devices.

Therefore, it would be desirable to have systems and methods that can select the most suitable destination storage devices among multiple candidates, e.g., storage devices that require the lowest amount of data transfer, prior to the transfer, such as to effectively reduce the total amount of data stored, regardless of the destination device type.

### SUMMARY

In some aspects of the disclosure, systems and methods can determine a destination storage device among several candidate storage devices based on a data match rate. A management system obtains from a source storage device, which has a source volume, information regarding a source volume. The information may be fingerprint information or other information related to data match rates that can be used to estimate, e.g., a data duplication rate. The management device communicates such information to candidate destination storage devices. In response, each candidate destination storage device uses a storage consumption estimation module to compare the received fingerprint information, with its own fingerprint information to estimate an amount of data consumption would the data be transferred and stored. The candidate destination storage devices communicate their estimated amounts to the management system, which uses a storage device selection module to select a destination storage. This may be accomplished by selecting a destination device associated with the lowest estimated amount of stored data. As a result, when multiple candidate data transfer destination storage devices are present for remote copy or data migration operations, based on the selectable data match ratio, the amount of storage consumption and, thus, storage capacity costs can be minimized.

In some aspects of the disclosure, a process for managing the transfer of data from a source storage system includes: obtaining, from one or more volumes of a source storage system, first fingerprint information; providing the first fingerprint information to candidate storage systems; receiving, from the candidate storage systems, estimates indicative of an amount of data storage each of the candidate storage systems would require to store the data once it is transferred; based on the estimates, selecting, among the candidate storage systems, one or more destination storage systems to obtain selected storage systems; and transferring the data from the one or more volumes to at least the selected storage systems.

The one or more of the candidate storage systems may obtain an estimate by comparing the first fingerprint information with second fingerprint information that is associated with one or more of the candidate storage systems. Selecting one or more destination storage systems may include selecting a destination storage system associated with the lowest estimate among the estimates. Comparing may further include comparing the first fingerprint information with a subset of the second fingerprint information to reduce a computational cost without significantly reducing an estimate accuracy. The first fingerprint information may be provided to the candidate storage systems in response to determining one or more properties associated with at least a subset of the candidate storage system. The one or more properties may include a data access pattern that is associated with at least one of read data, write data, a data length, or a time series. They may also include a volume label associated with at least one of inventory information or account information. The second fingerprint information may be processed in a tree format. The first fingerprint information may include a compression ratio of non-duplicated data.

In some aspects of the disclosure, a non-transitory computer-readable medium for storing instructions for executing some or all of the steps of the above-mentioned process. In some aspects of the disclosure, a system for reducing a data transfer volume may include: a management system configured to receive first information associated with at least one of fingerprint information, a data access pattern, a data duplication rate, a volume label, or a compression ratio; a source storage communicatively coupled to the management system, the source storage configured to provide the first information to the management system; and a candidate storage systems communicatively coupled to the management system, each of the candidate storage systems configured to use the first to generate an estimate of an amount of data to be stored on that candidate storage system, wherein the management system is configured to use the estimates to select one or more destination storage systems among the candidate storage systems, such that a transfer volume from the source storage to at least one of the one or more destination storage systems is reduced.

Aspects of the present disclosure can involve a system, which can involve means for obtaining, from one or more volumes of a source storage system, first fingerprint information; providing the first fingerprint information to candidate storage systems; receiving, from the candidate storage systems, estimates indicative of an amount of data storage each of the candidate storage systems would require to store the data once it is transferred; based on the estimates, selecting, among the candidate storage systems, one or more destination storage systems to obtain selected storage systems; and transferring the data from the one or more volumes to at least the selected storage systems

### BRIEF DESCRIPTION OF DRAWINGS

FIG. 1A illustrates an information handling system for reducing a data transfer volume, in accordance with example implementations.

FIG. 1B illustrates the information handling system in FIG. 1A that copies data to several volumes, in accordance with example implementations.

FIG. 2 provides additional details regarding the information handling systems shown in FIG. 1A and FIG. 1B.

FIG. 3 illustrates information and service modules of a storage management device, in accordance with an example implementation.

FIG. 4 illustrates information and service modules of a storage device, in accordance with an example implementation.

FIG. 5 illustrates an exemplary storage device information database depicted in FIG. 2.

FIG. 6 illustrates an exemplary volume fingerprint information database depicted in FIG. 4.

FIG. 7 illustrates an exemplary fingerprint information database depicted in FIG. 4.

FIG. 8 illustrates an exemplary volume deduplication and compression ratio information database depicted in FIG. 4.

FIG. 9 illustrates an exemplary request message for selecting a destination storage device, in accordance with an example implementation.

FIG. 10 illustrates an exemplary process for a policy-based storage service, in accordance with an example implementation.

FIG. 11 illustrates an exemplary process for a storage device selection module in a storage management device, in accordance with an example implementation.

FIG. 12 illustrates an exemplary process for data pattern information communication in the context of policy-based storage, in accordance with an example implementation.

FIG. 13 illustrates an exemplary process for a storage consumption estimation module implemented on a candidate storage device, in accordance with an example implementation.

FIG. 14 is a flowchart for an exemplary process for managing transfer of data from a source storage system, in accordance with an example implementation.

FIG. 15 illustrates an example computing environment with an example computer device suitable for use in some example implementations.

### DETAILED DESCRIPTION

The following detailed description provides details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of ordinary skill in the art practicing implementations of the present application. Selection can be conducted by a user through a user interface or other input means, or can be implemented through a desired algorithm. Example implementations as described herein can be utilized either singularly or in combination and the functionality of the example implementations can be implemented through any means according to the desired implementations. In this document the terms “device” and “system;” “candidate storage device” and “candidate destination storage device;” and “fingerprint information” and “data pattern information” may be used interchangeably.

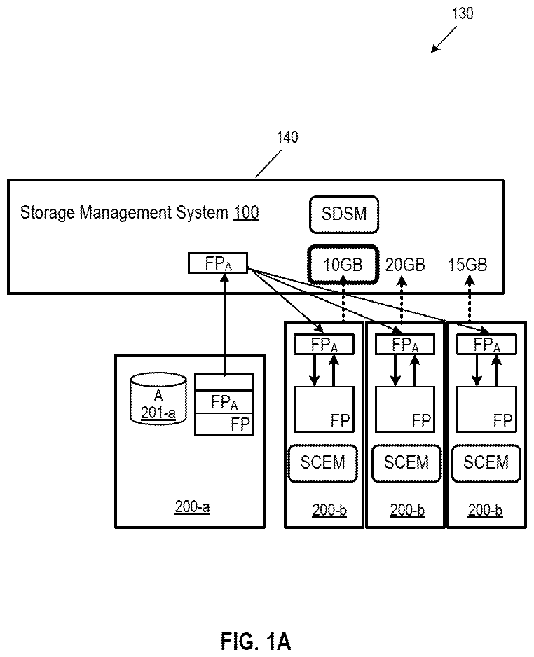

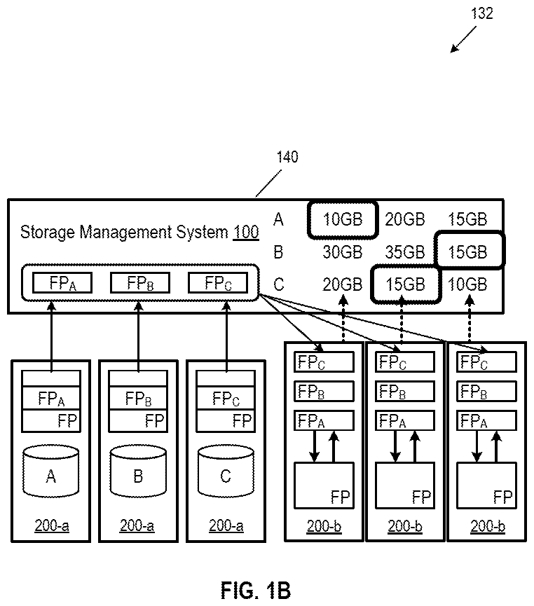

FIG. 1A and FIG. 1B illustrate information handling systems for reducing a data transfer volume when data is copied to one or more several volumes, in accordance with example implementations. In embodiments, system 150 comprises storage management device 100; source storage device 200-a; source volume 201-a (labeled “A” in FIG. 1A), and candidate storage devices 200-b, respectively. Each of source storage device 200-a and candidate storage devices 200-b may comprise a repository to store fingerprint-type information and other relevant data match rate details associated at least with volume 201-a. In addition, storage management device 100 comprises a storage device selection module (labeled SDSM); and each candidate storage device 200-b comprises a storage consumption estimation module (labeled SCEM).

In operation, storage management device 100 obtains data match rate information for volume 201-a from source storage device 200-a to initiate a process that selects one or more destination storage devices 200-b based on such information. Storage management device 100 then transmits the information, e.g., fingerprint information to each of candidate storage devices 200-b.

Once a candidate storage device 200-b receives that information, it may utilize its SCEM to compare received fingerprint information with fingerprint data it has already stored locally. The comparison allows each candidate storage device 200-b to estimate the an amount of post-transfer data that would be stored on candidate storage device 200-b in the event of a data transfer. Each candidate storage device 200-b then respond to management system 100 with its respective estimate.

In response, management system uses the estimates to select the most suitable storage device(s) among candidate storage systems 200-b as a destination storage device(s) for data transfer, e.g., by identifying the device that has the lowest estimated amount of stored data (10 GB in FIG. 1A). This approach successfully reduces the amount of data that needs to be transferred, thereby ensuring efficient storage resource utilization. As one of skill in the art will appreciate, data may be copied from any number of volumes to any number of volumes, and at the same time, using the principles as discussed with reference to FIG. 1A.

FIG. 1B illustrates an example in which three source storage devices, associated with respective source volumes, labeled “A,” “B,” and “C,” respectively, are employed. Similar to FIG. 1A, each volume may comprise its own fingerprint repository that stores information associated with that volume. And similar to storage management device 100 in system 130 in FIG. 1A, storage management device 100 in system 132 in FIG. 1B forwards the received fingerprint information to each of candidate storage devices 200-b. Each candidate storage device 200-b compares the received fingerprint information with its own fingerprint data to generate appropriate a transfer amount estimate associated with its volume.

Finally, to facilitate efficient data management and transfer operations, management system 100 then uses these estimates to select the most suitable storage device(s) among candidate storage systems 200-b as destination storage device(s), here, 10 GB for volume A, 15 GB for volume B, and 15 GB for volume C.

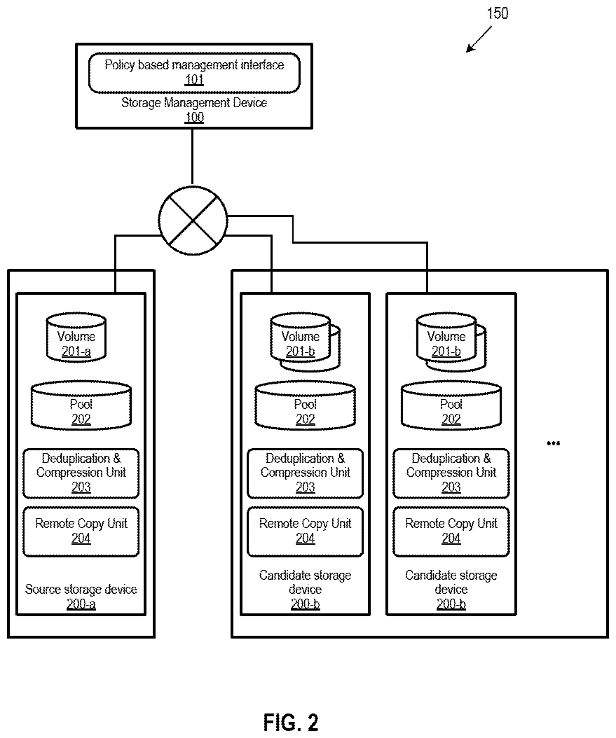

FIG. 2 provides additional details regarding the information handling systems shown in FIG. 1A and FIG. 1B. As depicted, information handling system 150 comprises storage management device 100, which comprises policy-based management interface 101 and network 104, not expressly shown in FIG. 1A and FIG. 1B. Each storage device comprises volume 201, storage pool 202, deduplication and compression unit 203, and remote copy unit 204. It is understood that each component of system 150 may be interconnected with other components via network 104 to enable data transfer and management tasks across system 150.

Policy-based management interface 101 provides an interface that can accommodate storage features such as volume migration or backup copies. These operations may be implemented by applying policies or conditions for the selection of destination devices based on various factors, such as data redundancy and storage efficiency, rather than dedicated individual destination devices. As discussed in greater detail further below, interface 101 is used to provide fingerprint information to candidate storage devices 200-b. Such information may be provided in a tree format and used for comparison and matching operations that enable a significant reduction in computational cost, while maintaining high accuracy when generating estimates for required storage capacities.

Volumes (e.g., 201) may serve as virtualized logical storage units that facilitate abstraction and management of remotely stored data. Pool (e.g., 202) represents aggregated storage capacity of attached media (e.g., HDD, SSD, etc.) attached to the storage devices. Deduplication and compression unit 203 is configured to deduplicate the data stored in storage devices, for example based on the fingerprint information (e.g., SHA-1, md5, etc.) that identify data patterns used to estimate storage requirements and select the most efficient storage configuration. Deduplication and compression unit 203 is further configured to compress data stored in storage devices using any known compression algorithm in the art to reduce storage consumption. Finally, remote copy unit 204 manages the copying operations between two storage devices.

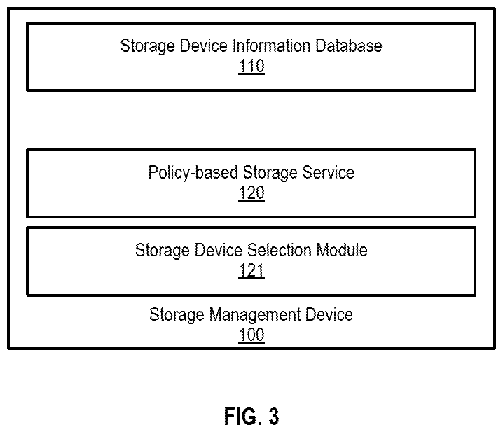

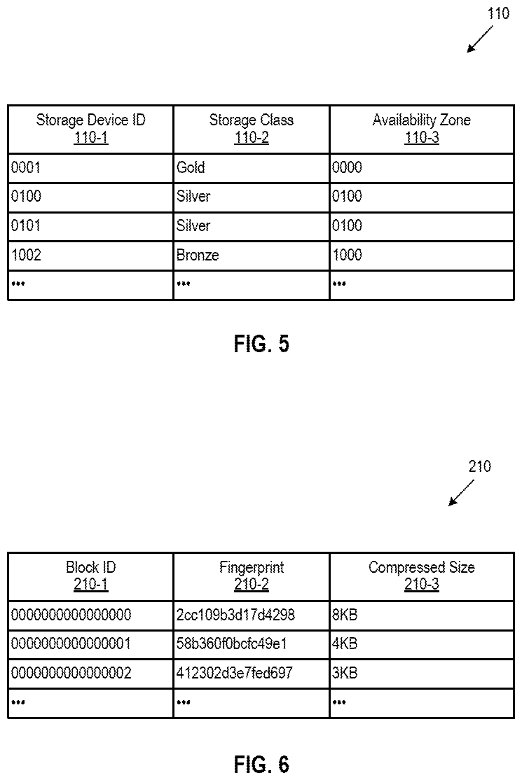

FIG. 3 illustrates information and service modules of a storage management device, including a storage device selection module, in accordance with an example implementation. Storage management device 100 comprises storage device information database 110 that compares information about storage devices used as remote copy source and destination that are communicatively coupled to storage management device 100. As discussed in greater detail with reference to FIG. 5, storage device information database 110 may further comprise data access patterns, volume labels, compression ratios, and other characteristics or parameters that may be used to facilitate a selection process based on specific characteristics of the data being processed. The information may be stored in the form of tables for easy access by software modules that execute a policy-based storage service. Policy-based storage service 120 may interpret policy-based requests from a storage operator and execute storage data services (e.g., remote copy operations, data migration, etc.) based on storage devices that are selected by storage device selection module 121. Policy-based storage service 120 may further use storage device selection module 121 to select destination storage devices based on storage consumption estimates obtained from any number of candidate storage devices. The gathered estimates may indicate an amount of data storage required by each candidate storage system. The estimates may take into consideration compression ratios and may be used to evaluate deduplication effectiveness when determining ways to reduce a data storage demand.

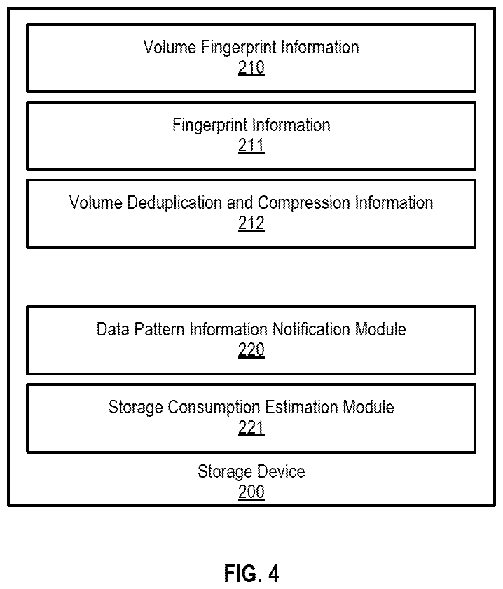

FIG. 4 illustrates information and service modules of a storage device in accordance with an example implementation. Certain features of storage device 200 may be implemented (e.g., in databases) in source storage devices and/or candidate storage devices. For example, volume fingerprint information 210, fingerprint Information 211, and data pattern information notification module 220 in storage device 200 in FIG. 4 may be implemented in source storage device 200-a in FIG. 2, and volume deduplication and compression information 212 and storage consumption estimation module 221 may be implemented in candidate storage devices 200-b in FIG. 2.

In embodiments, volume fingerprint information 210 and fingerprint information 211 components determine and store unique identifiers for each data block within a volume that, together with volume deduplication and compression information 212, enables deduplication in a volume (e.g., volume 201-a depicted in FIG. 2) by comparing data blocks to identify duplicates and reduce the transfer of redundant data. Data pattern information notification module 220 notifies storage management device 100 of data patterns (e.g., volume fingerprint information, volume deduplication and compression information) associated with a designated volume to enable an accurate estimation of storage capacity needs.

Storage consumption estimation module 221 calculates storage capacity consumption for a given volume to identify data patterns stored in candidate storage device 200-b. This information may be used to estimate storage requirements that candidate storage device 200-b communicates to storage management device 100.

FIG. 5 illustrates an exemplary storage device information database, in accordance with an example implementation. In embodiments, information in database 110 may be stored in storage management device 100 in the form of a table comprising columns for storage device ID 110-1, storage class 110-2, and availability zone 110-3 and comprise information about storage devices that are used as remote copy source and destination that are communicatively coupled to storage management device 100.

Storage device ID 110-1 presents identifiers for candidate storage devices; storage class 110-2 assigns names or labels based on policies such as access frequency or other parameters, e.g., to guide a selection of destination devices or data storage; and availability zone 110-3 define geographical or logical regions to which a storage device is assigned. Such identifiers and classifiers aid the policy-based management of storage resources by enabling intelligent decisions for efficiently executing data transfer and management commands.

FIG. 6 illustrates an exemplary volume fingerprint information database depicted in FIG. 4. In embodiments, volume fingerprint information database 210 may be implemented in a source storage device, e.g., in the form of a table that comprises columns for block ID 210-1, fingerprint 210-true, and compressed size 210-3. Database 210 stores unique identifiers for each data block to enable deduplication in various volumes. Block ID 210-1 represents an identification number for a data block within a volume. Fingerprint column 210-2 represents hash values (such as SHA-1, md5) associated with the content of each data block. Values in fingerprint column 210-2 are used to identify duplicate data across the information handling system. Compressed size 210-3 represents a post-compression data size of data blocks, indicating a storage requirement for an actual size. This information aids in decision-making and the management of storage resources and, thus, in accomplishing the objectives of the present disclosure.

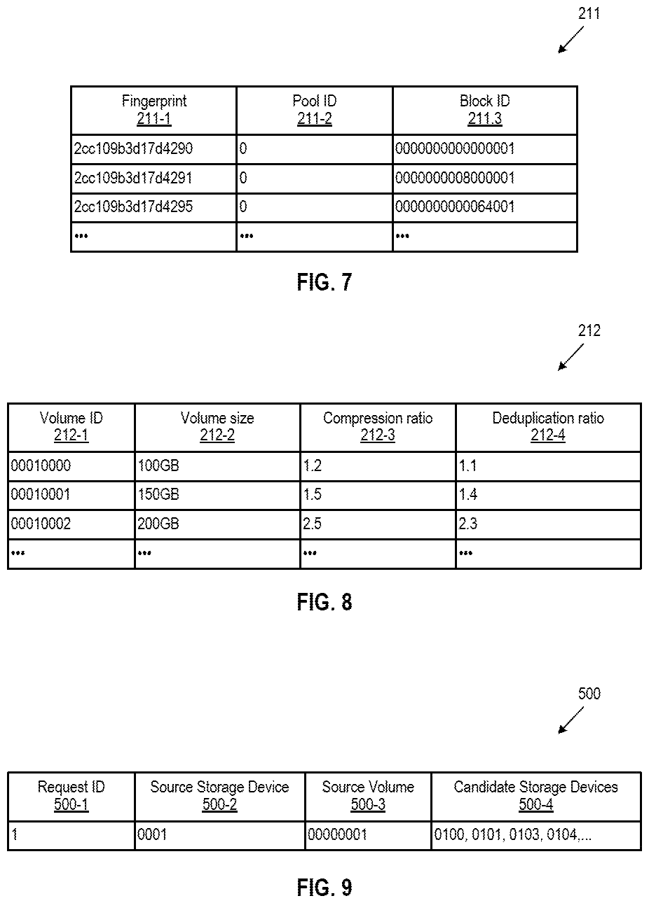

FIG. 7 illustrates an exemplary fingerprint information database depicted in FIG. 4. In embodiments, database 211 may be implemented in a candidate storage device and stored in form of a table comprising columns for fingerprint 211-1, pool ID 211-2, and block ID 211-3. Database 211 stores fingerprint information that can be used to track data patterns across the information handling system. Fingerprint 211-1 represents the data pattern of a data block, such as hash values, which can be used to search for duplicate data. Pool ID 211-2 and block ID 211-3 represent that associate data blocks to storage pools.

FIG. 8 illustrates an exemplary volume deduplication and compression ratio information database depicted in FIG. 4. In embodiments, database 212 in storage device 200 may be stored in form of a table comprising columns for volume ID 212-1, volume size 212-2, compression ratio 212-3, and deduplication ratio 212-4. Database 212 stores capacity information and the effects of data reduction by enabling deduplication and compression for each volume. Volume ID 212-1 in database 212 acts as a unique identifier that identifies each volume within a storage device. Volume size 212-2, compression ratio 212-3, and deduplication ratio 212-4 are metrics that quantify the impact of deduplication and compression on storage efficiency.

FIG. 9 illustrates an exemplary request message for selecting destination storage devices, in accordance with an example implementation. As depicted, request message 500 comprises columns for request ID 500-1, source storage device ID 500-2, source volume ID 500-3, and candidate storage device 500-4 that can be used to interpret policy-based storage requests and storage operation commands. In embodiments, policy-based storage service 120 communicates request message 500 to storage device selection module 121 to identify one or more candidate storage devices. Request ID 500-1 is an identifier that uniquely identifies request message 500. Source storage device ID 500-2 identifies a source storage device such as device 200-a in FIG. 2. Source volume ID 500-3, identifies a source volume such as 201-b in FIG. 2. The 500-4 for candidate storage device 500-4 comprises a list of candidate storage devices for remote copy that are selected based on storage efficiency metrics.

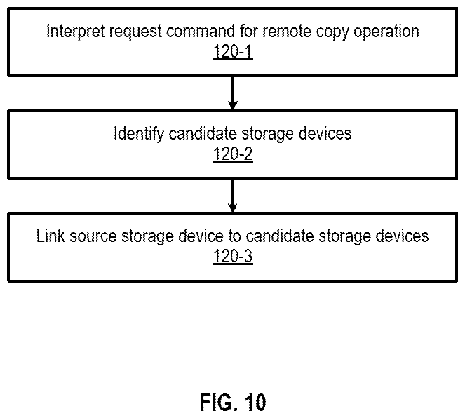

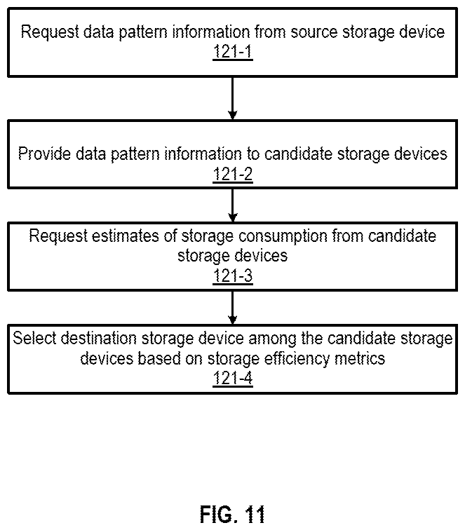

FIG. 10 illustrates an exemplary process for a policy-based storage service, in accordance with an example implementation. The process for policy-based storage service (shown in FIG. 3) may start at step 120-1, when, in response to a storage operator initiating a request command for the remote copy operation, e.g., via policy-based management interface 101 (shown in FIG. 1) the request command is interpreted. In this example, the storage class and availability zone associated with storage devices designated for remote copying may be included in the request command.

At step 120-2, a request message (e.g., request message 500 that identifies potential candidate storage devices) may be created and communicated to storage device selection module 121 to select a destination storage device among candidate storage devices in list 500-4 (shown in FIG. 9). Potential candidate storage devices may be identified based on storage class and availability zones that are included in request parameters associated with the policy-based operation and information in storage device information database 110 (shown in FIG. 3).

At step 120-3, once the possible candidate storage devices are identified as potential destinated storage devices (e.g., according to request message 500 received at policy-based management interface 101), a remote copy pair may be created that links a source storage device to candidate storage devices defined by storage device selection module 121.

FIG. 11 illustrates an exemplary process for a storage device selection module in a storage management device, in accordance with an example implementation. The process starts at step 121-1, when policy-based storage service 120 implemented in storage management device 100 requests, from a source storage device (e.g., source storage device 500-2 identified in FIG. 9), data pattern information associated with a source volume (e.g., source volume 500-3 information depicted in FIG. 9).

At step 121-2, in response to policy-based storage service 120 obtaining the requested data pattern information from the source storage device, storage management device 100 may provide that information to candidate storage devices listed on candidate storage device list 500-4 (shown in FIG. 9)

At step 121-3, storage management device 100 requests from the candidate storage devices estimates associated with the effectiveness of deduplication of source volume 500-3 were source volume 500-3 stored on each respective candidate storage device present in list 500-4. It is note that the storage device selection module in storage management device may receive estimates of storage consumption, such as estimates of the effectiveness of deduplication, from each candidate storage device.

At step 121-4, in response to receiving the estimates from the candidate storage devices, the storage device selection module may select as a destination storage device, among the candidate storage devices on the list, one storage device that has the lowest estimated storage consumption based on the estimates. The selection of suitable destination storage devices can be made based on storage efficiency metrics to ensure that data is efficiently deduplicated and stored.

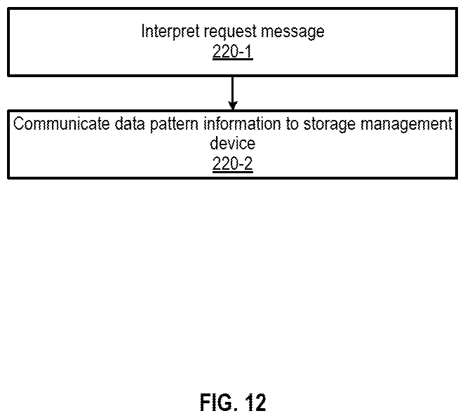

FIG. 12 illustrates an exemplary process for data pattern information communication in the context of policy-based storage, in accordance with an example implementation. The process for a data pattern information notification module (shown, e.g., in FIG. 4) in a source storage device may start at step 220-1, when the source storage device receives a request for data pattern information (e.g., request 121-1 in FIG. 11). The request may be received in the form of a message that is interpreted as identifying a specific volume, e.g., by volume ID. An example of data pattern information is a fingerprint associated with a data block within a volume (e.g., 210-1). Another example is the compression ratio of the volume (e.g., 212-3).

At step 220-2, once the data pattern information associated with the volume is obtained (e.g., from volume fingerprint information table 210), it is communicated to storage management device 100 for distribution to any number of candidate destination storage devices, as previously mentioned.

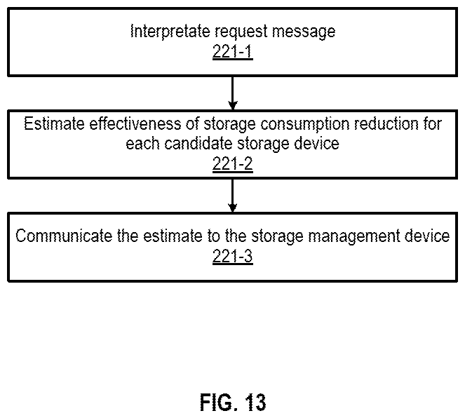

FIG. 13 illustrates an exemplary process for a storage consumption estimation module implemented on a candidate storage device, in accordance with an example implementation. The process may start at step 221-1, when a candidate storage device receives a request for estimation of the effectiveness of reducing storage consumption by deduplication.

At step 221-2, the candidate storage device estimates the effectiveness of reducing storage consumption by deduplication were the data stored in that candidate storage device. In one exemplary method of estimating effectiveness, the storage consumption estimation module implemented in a candidate storage device compares fingerprint information in a volume fingerprint information table, which is obtained as data pattern information by storage management device 100, with fingerprint information maintained by the candidate storage device itself. In another example, estimating effectiveness involves a storage consumption estimation module (e.g., shown in FIG. 4) computing the number of volumes whose compression ratios are close to those obtained from the storage management device.

Finally, at step 221-3, candidate storage devices may communicate their estimates to the storage management device to initiate the selection process.

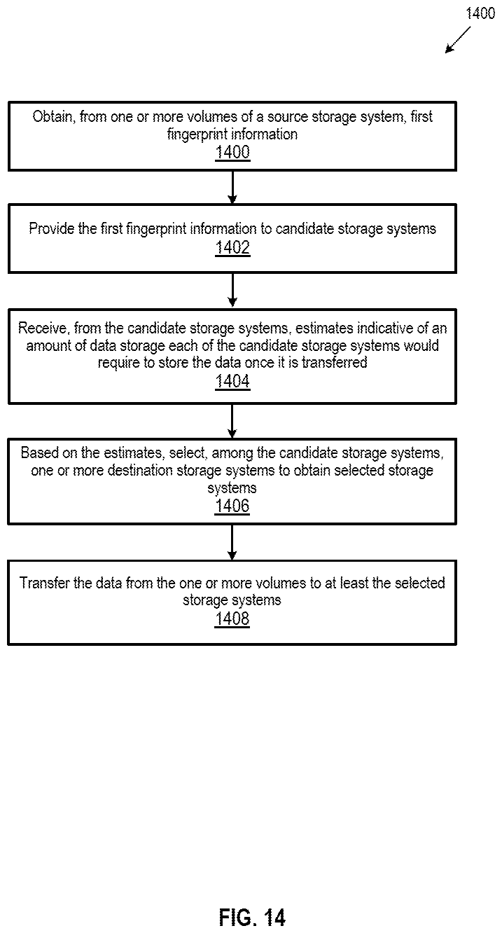

FIG. 14 is a flowchart for an exemplary process for managing a transfer of data from a source storage system, in accordance with an example implementation. Process 1400 may start at step 1400, when fingerprint information is obtained from one or more volumes of a source storage system. At step 1402, the fingerprint information is provided to candidate storage systems, which generate estimates indicative of an amount of data storage each of the candidate storage systems would require to store the data if the data were transferred. Upon receiving the estimates from the candidate storage systems, at step 1404, one or more destination storage systems among the candidate storage systems are selected, at step 1406, based on the estimates to obtain selected storage systems. Finally, at step 1408, the data is transferred from the one or more volumes to at least the selected storage systems.

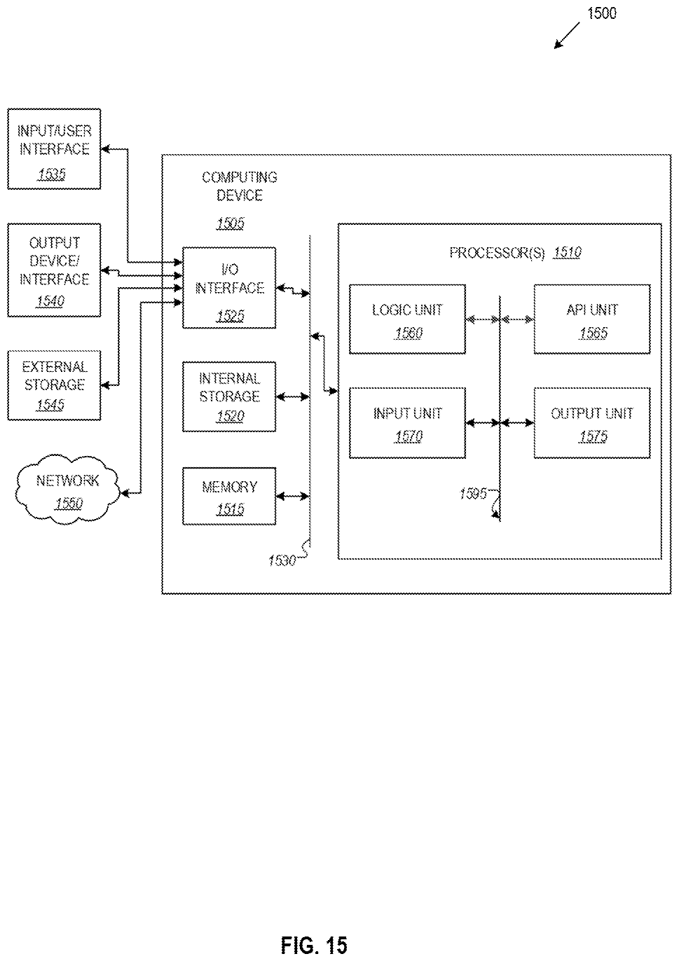

FIG. 15 illustrates an example computing environment with an example computer device suitable for use in some example implementations, such storage management device 100 as illustrated in FIG. 1. Processor(s) 1510 can be configured to execute a method or computer instructions which can involve obtaining, from one or more volumes of a source storage system, first fingerprint information, as shown in FIG. 1A. The first fingerprint information may be provided to candidate storage systems, such as candidate storage systems 200-b shown in FIG. 1A or FIG. 1B. The storage management device may receive, from the candidate storage systems, estimates indicative of an amount of data storage each of the candidate storage systems would require to store the data once it is transferred. Then, based on the estimates, the storage management device may select, among the candidate storage systems, one or more destination storage systems to obtain selected storage systems, before transferring the data from the one or more volumes to at least the selected storage systems, shown in FIG. 1A, FIG. 1B, and FIG. 2.

Computer device 1505 in computing environment 1500 can include one or more processing units, cores, or processors 1510, memory 1515 (e.g., RAM, ROM, and/or the like), internal storage 1520 (e.g., magnetic, optical, solid-state storage, and/or organic), and/or I/O interface 1525, any of which can be coupled on a communication mechanism or bus 1530 for communicating information or embedded in the computer device 1505. I/O interface 1525 is also configured to receive images from cameras or provide images to projectors or displays, depending on the desired implementation.

Computer device 1505 can be communicatively coupled to input/user interface 1535 and output device/interface 1540. Either one or both of input/user interface 1535 and output device/interface 1540 can be a wired or wireless interface and can be detachable. Input/user interface 1535 may include any device, component, sensor, or interface, physical or virtual, that can be used to provide input (e.g., buttons, touch-screen interface, keyboard, a pointing/cursor control, microphone, camera, braille, motion sensor, optical reader, and/or the like). Output device/interface 1540 may include a display, television, monitor, printer, speaker, braille, or the like. In some example implementations, input/user interface 1535 and output device/interface 1540 can be embedded with or physically coupled to the computer device 1505. In other example implementations, other computer devices may function as or provide the functions of input/user interface 1535 and output device/interface 1540 for a computer device 1505.

Examples of computer device 1505 may include highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 1505 can be communicatively coupled (e.g., via I/O interface 1525) to external storage 1545 and network 1550 for communicating with any number of networked components, devices, and systems, including one or more computer devices of the same or different configuration. Computer device 1505 or any connected computer device can be functioning as, providing services of, or referred to as a server, client, thin server, general machine, special-purpose machine, or another label.

I/O interface 1525 can include wired and/or wireless interfaces using any communication or I/O protocols or standards (e.g., Ethernet, 802.11x, Universal System Bus, WiMax, modem, a cellular network protocol, and the like) for communicating information to and/or from at least all the connected components, devices, and network in computing environment 1500. Network 1550 can be any network or combination of networks (e.g., the Internet, local area network, wide area network, a telephonic network, a cellular network, a satellite network, and the like).

Computer device 1505 can use and/or communicate using computer-usable or computer-readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid-state media (e.g., RAM, ROM, flash memory, solid-state storage), and other non-volatile storage or memory.

Computer device 1505 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C#, Java, Visual Basic, Python, Perl, JavaScript, and others).

Processor(s) 1510 can execute under any operating system (OS) (not shown), in a native or virtual environment. One or more applications can be deployed that include logic unit 1560, application programming interface (API) unit 1565, input unit 1570, output unit 1575, and inter-unit communication mechanism 1595 for the different units to communicate with each other, with the OS, and with other applications (not shown). The described units and elements can be varied in design, function, configuration, or implementation and are not limited to the descriptions provided. Processor(s) 1510 can be in the form of hardware processors such as central processing units (CPUs) or in a combination of hardware and software units.

In some example implementations, when information or an execution instruction is received by API unit 1565, it may be communicated to one or more other units (e.g., logic unit 1560, input unit 1570, output unit 1575). In some instances, logic unit 1560 may be configured to control the information flow among the units and direct the services provided by API unit 1565, input unit 1570, output unit 1575, in some example implementations described above. For example, the flow of one or more processes or implementations may be controlled by logic unit 1560 alone or in conjunction with API unit 1565. The input unit 1570 may be configured to obtain input for the calculations described in the example implementations, and the output unit 1575 may be configured to provide output based on the calculations described in example implementations.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer-readable medium, such as a computer-readable storage medium or a computer-readable signal medium. A computer-readable storage medium may involve tangible mediums such as optical disks, magnetic disks, read-only memories, random access memories, solid-state devices and drives, or any other types of tangible or non-transitory media suitable for storing electronic information. A computer-readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the techniques of the example implementations as described herein. The instructions of the programming language(s) may be executed by one or more processing devices, e.g., central CPUs, processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general-purpose computer, based on instructions stored on a computer-readable medium. If desired, the instructions can be stored on the medium in a compressed and/or encrypted format.

Moreover, other implementations of the present application will be apparent to those skilled in the art from consideration of the specification and practice of the techniques of the present application. Various aspects and/or components of the described example implementations may be used singly or in any combination. It is intended that the specification and example implementations be considered as examples only, with the true scope and spirit of the present application being indicated by the following claims.

What is claimed is:

1. A method for managing transfer of data from a source storage system, the method comprising:
obtaining, from one or more volumes of a source storage system, first fingerprint information;
providing the first fingerprint information to candidate storage systems;
receiving, from the candidate storage systems, estimates indicative of an amount of data storage each of the candidate storage systems would require to store the data once it is transferred;
based on the estimates, selecting, among the candidate storage systems, one or more destination storage systems to obtain selected storage systems; and
transferring the data from the one or more volumes to at least the selected storage systems.

2. The method of claim 1, wherein one or more of the candidate storage systems obtain an estimate by comparing the first fingerprint information with second fingerprint information that is associated with one or more of the candidate storage systems.

3. The method of claim 2, wherein selecting one or more destination storage systems comprises selecting a destination storage system associated with the lowest estimate among the estimates.

4. The method of claim 2, wherein comparing comprises comparing the first fingerprint information with a subset of the second fingerprint information to reduce a computational cost without significantly reducing an estimate accuracy.

5. The method of claim 2, wherein the first fingerprint information is provided to the candidate storage systems in response to determining one or more properties associated with at least a subset of the candidate storage system.

6. The method of claim 5, wherein the one or more properties comprise a data access pattern that is associated with at least one of read data, write data, a data length, or a time series.

7. The method of claim 5, wherein the one or more properties comprise a volume label associated with at least one of inventory information or account information.

8. The method of claim 2, wherein the second fingerprint information is processed in a tree format.

9. The method of claim 1, wherein the first fingerprint information comprises a compression ratio of non-duplicated data.

10. A non-transitory computer-readable medium for storing instructions for executing a process, the instructions comprising:
at a management system, receiving, from a source node, first information associated with a data match rate;
providing the first information to candidate storage systems that each uses the first information to generate an estimate of an amount of data to be stored on the candidate storage system;
in response to obtaining the estimates, selecting one or more destination storage systems among the candidate storage systems to reduce an amount of data to be transferred to at least one of the one or more destination storage systems; and
causing the data to the transferred from the source node to the at least one destination storage system.

11. The non-transitory computer-readable medium of claim 10, wherein generating the estimate comprises comparing the first information to second information associated with the candidate storage systems.

12. The non-transitory computer-readable medium of claim 11, wherein comparing comprises comparing the first information with a subset of the second information to reduce a computational demand.

13. The non-transitory computer-readable medium of claim 11, wherein selecting the one or more destination storage systems comprises selecting a destination storage system associated with the lowest estimate among the estimates.

14. The non-transitory computer-readable medium of claim 11, wherein at least one of the first information or the second information comprises at least one of fingerprint information, a data access pattern, a data duplication rate, a volume label, or a compression ratio.

15. The non-transitory computer-readable medium of claim 11, wherein the first information is provided to the candidate storage systems in response to determining one or more properties associated with at least a subset of the candidate storage systems.

16. A system for reducing a data transfer volume, the system comprising:
a management system configured to receive first information associated with at least one of fingerprint information, a data access pattern, a data duplication rate, a volume label, or a compression ratio;
a source storage communicatively coupled to the management system, the source storage configured to provide the first information to the management system; and
a candidate storage systems communicatively coupled to the management system, each of the candidate storage systems is configured to use the first to generate an estimate of an amount of data to be stored on that candidate storage system, wherein the management system is configured to use the estimates to select one or more destination storage systems among the candidate storage systems, such that a transfer volume from the source storage to at least one of the one or more destination storage systems is reduced.

17. The system of claim 16, wherein the management system uses a storage device selection module to select a destination storage system that is associated with the lowest estimate among the estimates.

18. The system of claim 16, wherein the candidate storage systems generate the estimates by using a storage consumption estimation module to compare the first information to second information associated with the candidate storage systems.

19. The system of claim 18, wherein the candidate storage systems compare the first information with a subset of the second information to reduce a computational cost.

20. The system of claim 16, wherein management system provides the first information to the candidate storage systems in response to determining one or more properties associated with at least a subset of the candidate storage systems.
